(19) United States
(12) Patent Application Publication
(10) Pub. No.: US 2024/0113403 A1
(43) Pub. Date: Apr. 4, 2024

(54) ELECTROLYTE INJECTION SYSTEM OF SECONDARY BATTERY

(71) Applicant: SK ON CO., LTD., Seoul (KR)

(72) Inventors: Jae Min RYU, Daejeon (KR); Sang Jun PARK, Daejeon (KR); Kang San KIM, Daejeon (KR); Ji Eun AHN, Daejeon (KR); Young Rae OH, Daejeon (KR)

(21) Appl. No.: 18/359,869

(22) Filed: Jul. 27, 2023

(30) Foreign Application Priority Data
Oct. 4, 2022 (KR) 10-2022-0126453

(51) Int. Cl. H01M 50/609

(52) U.S. Cl. CPC H01M 50/609

(57) ABSTRACT

The present disclosure relates to an electrolyte injection system, and the electrolyte injection system is a system for injecting an electrolyte solution into a pouch in which an electrode assembly is embedded, the electrolyte injection system comprising: an injection pipe for injecting an electrolyte solution; an electrolyte solution supply portion supplying an electrolyte solution; and a manifold portion connecting an injection pipe and an electrolyte solution supply portion to prevent a reverse flow of the electrolyte solution and ensure precision of injection amount so that a large amount of electrolyte solution may be accurately and rapidly injected.

### CROSS-REFERENCE TO RELATED PATENT APPLICATION

The present application claims priority under 35 U.S.C. § 119(a) to Korean patent application number 10-2022-0126453 filed on Oct. 4, 2022, in the Korean Intellectual Property Office, the entire disclosure of which is incorporated by reference herein.

### BACKGROUND OF THE INVENTION

### 1. Field

The present disclosure relates to an electrolyte injection system, more specifically, an electrolyte injection system capable of preventing the generation of a vortex of an electrolyte solution in the process of injecting an electrolyte solution into a pouch.

### 2. Description of the Related Art

As the electronics, communications, and space industries develop, demand for lithium secondary batteries as an energy power source is drastically increasing. In particular, as the importance of global eco-friendly policies is emphasized, the electric vehicle market is growing swiftly, and research and development on lithium secondary batteries are being actively conducted worldwide.

Among various secondary batteries, research on lithium secondary batteries, having high discharge voltage and energy density, is being most actively conducted. Such a lithium secondary battery is manufactured by accommodating an electrode assembly including an anode, a cathode, and a separator in a pouch-type case having high flexibility, impregnating an electrolyte solution, and then heat-sealing edges of the case.

Lithium secondary batteries use an electrolyte solution, which is a liquid-state electrolyte. An electrolyte solution plays a key role in batteries by enabling the migration of lithium ions between a cathode and an anode, stabilizing the surfaces of the cathode and anode, and improving battery life and cell characteristics.

An electrolyte solution pump and a fill tube are used to inject an electrolyte solution into a pouch accommodating an electrode assembly, and a dual fill tube can be used when a large amount of liquid needs to be injected. To supply an electrolyte solution to a dual fill tube, an electrolyte solution should be branched by using a manifold. However, when an electrolyte solution is branched with a long tubular manifold, there is a problem that the precision is not guaranteed due to the generation of a vortex.

### SUMMARY OF THE INVENTION

The present disclosure provides an electrolyte injection system capable of ensuring the precision of an injection amount by improving the shape of a manifold.

An electrolyte injection system according to the present disclosure may comprise an injection pipe for injecting the electrolyte solution through an opening formed on the battery pouch, an electrolyte solution supply portion comprising an electrolyte solution pump, and a manifold portion connecting the injection pipe and the electrolyte solution supply portion, wherein the manifold portion may comprise at least one Y-shaped manifold.

In one Example of the present disclosure, the manifold may comprise a first coupling hole for receiving the electrolyte solution from the electrolyte solution supply portion and a second coupling hole for supplying the electrolyte solution introduced through the first coupling hole to the injection pipe.

In one Example of the present disclosure, a second coupling hole may be located relatively lower than the first coupling hole so that the manifold may form an inclination.

In one Example of the present disclosure, the manifold portion may further comprise a connecting portion connected to the second coupling hole.

In one Example of the present disclosure, the electrolyte solution pump may be located above the manifold.

In one Example of the present disclosure, the electrolyte solution supply portion may further comprise an electrolyte solution transfer hose for transferring the electrolyte solution to the manifold.

In one Example of the present disclosure, the electrolyte solution supply portion may further comprise a control valve controlling supply of the electrolyte solution.

In one Example of the present disclosure, the manifold may comprise a cross-shaped manifold.

By comprising a manifold having an improved shape, the present disclosure may prevent a vortex generated during the injection of an electrolyte solution to ensure the precision of an injection amount. Through this, a battery pouch may be impregnated with a precise amount of electrolyte solution to ensure the safety of a pouch-type battery.

In addition, even when a large amount of liquid needs to be injected, the present disclosure may provide a rapid and precision-securing electrolyte injection system for being able to be provided with a plurality of discharge holes of a manifold portion.

In addition, the time required to inject a large amount of electrolyte solution into a battery pouch is reduced, thereby improving productivity.

### BRIEF DESCRIPTION OF THE DRAWINGS

FIG. 1 is a diagram schematically illustrating an electrolyte solution injection process of a battery.

FIGS. 2 and 3 are diagrams illustrating an electrolyte injection system according to an Example of the present disclosure.

FIG. 4 is a diagram illustrating a manifold portion and an injection pipe according to an Example of the present disclosure.

FIG. 5 is a diagram illustrating an electrolyte injection system according to an Example of the present disclosure.

FIG. 6 is an enlarged diagram illustrating area A of FIG. 4.

FIG. 7 is a diagram illustrating a manifold portion and an injection pipe according to another Example of the present disclosure.

FIG. 8 is an enlarged diagram illustrating area A′ of FIG. 7.

### DETAILED DESCRIPTION

Structural or functional descriptions of Examples disclosed in the present specification or application are merely illustrated for the purpose of describing Examples according to the technical principle of the present disclosure. In addition, Examples according to the technical principle of the present disclosure may be implemented in various forms other than the Examples disclosed in the present specification or application. In addition, the technical principle of the present disclosure is not to be construed as being limited to the Examples described in this specification or application.

Hereinafter, a secondary battery electrolyte injection system according to an Example of the present disclosure will be described in detail with reference to the accompanying drawings.

A secondary battery according to the present disclosure comprises a cathode, an anode, and a separator interposed between the cathode and the anode, which can improve the performance of the secondary battery described above.

A secondary battery according to the present disclosure refers to a secondary battery that can be repeatedly used by charging and discharging electrical energy. For example, it may be a lithium secondary battery, but is not limited thereto.

Secondary batteries may be classified into a pouch-type secondary battery, a prismatic secondary battery, or a cylindrical secondary battery according to the shape thereof. For convenience of description, the present Specification illustrates a pouch-type secondary battery as an example, but is not limited thereto.

According to an Example, a secondary battery can be manufactured according to a known method, and specifically, it can be manufactured by inserting a porous separator between a cathode and an anode and injecting an electrolyte solution.

According to an Example, a cathode may comprise a cathode current collector and a cathode material, and an anode may comprise an anode current collector and an anode material. An anode current collector may comprise any one of stainless steel, nickel, aluminum (Al), titanium (Ti), copper (Cu), and alloys thereof and may be provided in various forms such as a film, a sheet and a foil. An anode material may comprise an anode active material. An anode active material may be a material capable of intercalating and deintercalating lithium ions. For example, an anode active material may be any one of carbon-based materials, such as crystalline carbon, amorphous carbon, carbon composites, and carbon fibers, lithium alloys, silicon (Si), and tin (Sn). According to an Example, an anode active material may be natural graphite or artificial graphite, but is not limited thereto. In addition, according to an Example, an anode material may further comprise a binder and a conductive material.

An electrolyte solution may be a non-aqueous electrolyte. An electrolyte solution may further comprise a lithium salt and an organic solvent. For example, an organic solvent may comprise at least one selected from the group consisting of propylene carbonate (PC), ethylene carbonate (EC), diethyl carbonate (DEC), dimethyl carbonate (DMC), ethylmethyl carbonate (EMC), methylpropyl carbonate (MPC), dipropyl carbonate (DPC), vinylene carbonate (VC), dimethyl sulfoxide, acetonitrile, dimethoxyethane, diethoxyethane, sulfolane, gamma-butyrolactone, propylene sulfide, and tetrahydrofuran.

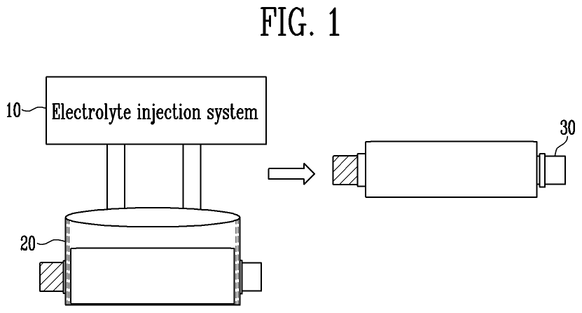

FIG. 1 is a diagram schematically illustrating an electrolyte solution injection process of a battery.

Referring to FIG. 1, a battery pouch 20 may accommodate an electrode assembly formed by comprising a cathode, an anode, and a separator interposed between the cathode and the anode. An electrolyte injection system 10 may impregnate an electrode assembly by injecting an electrolyte solution into a battery pouch 20.

After accommodating an electrode assembly, a battery pouch 20 may seal the rest except for one side for injecting an electrolyte solution. In other words, one side of a battery pouch 20 may be opened for injecting an electrolyte solution.

An electrolyte injection system 10 may inject an electrolyte solution through one open side of a battery pouch 20.

An electrolyte solution injected into a pouch-type battery improves the characteristics of a cell by allowing lithium ions to well migrate between a cathode and an anode. Therefore, an electrolyte solution should be injected in a fixed amount considering the characteristics of the battery, and when an electrolyte solution is injected differently from a designed fixed amount, the migration of lithium ions and the electrode reaction may not be performed smoothly, which may deteriorate battery performance.

An electrolyte injection system 10 should be able to receive an electrolyte solution from the outside and inject the electrolyte solution into a battery pouch 20 as much as the designed volume. In addition, when a large amount of electrolyte solution is injected, the time for injection an electrolyte solution needs to be shortened. To this end, a plurality of injection tubes may be provided.

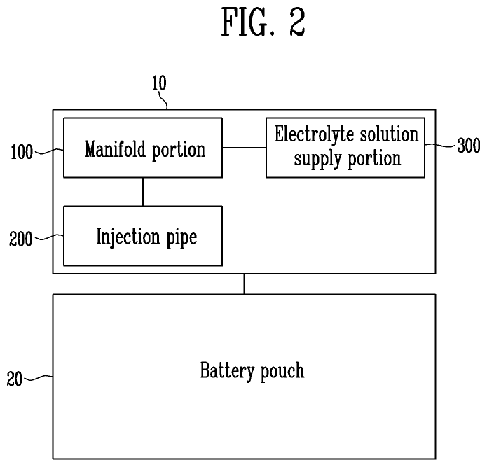

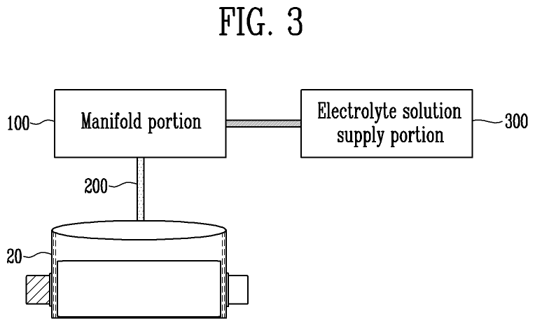

FIGS. 2 and 3 are diagrams illustrating an electrolyte injection system according to an Example of the present disclosure.

A secondary battery electrolyte injection device 10 of the present disclosure comprises an electrolyte solution supply portion 300 accommodating and supplying an electrolyte solution, an injection pipe 200 injecting an electrolyte solution into a battery pouch, and a manifold portion 100 connecting the electrolyte solution supply portion and the injection pipe to form an electrolyte solution movement path.

In other words, an electrolyte solution may be supplied by an electrolyte solution supply portion 300 and injected into a battery pouch via a manifold portion 100 and an injection pipe 200.

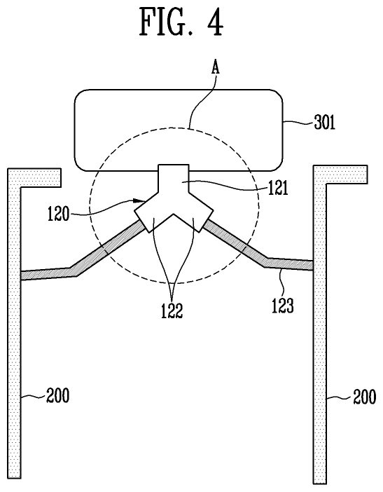

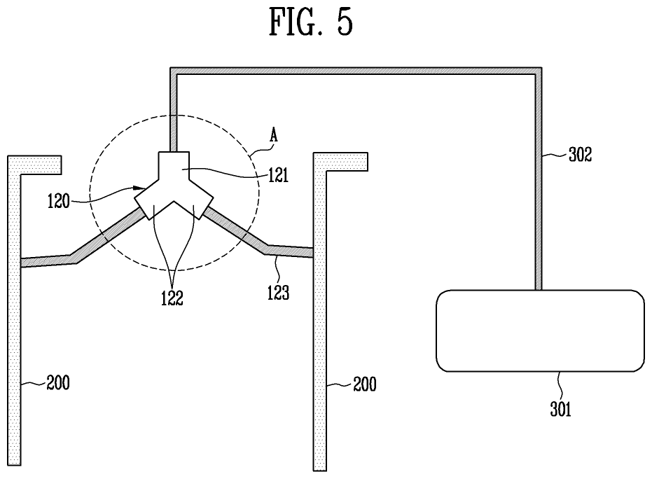

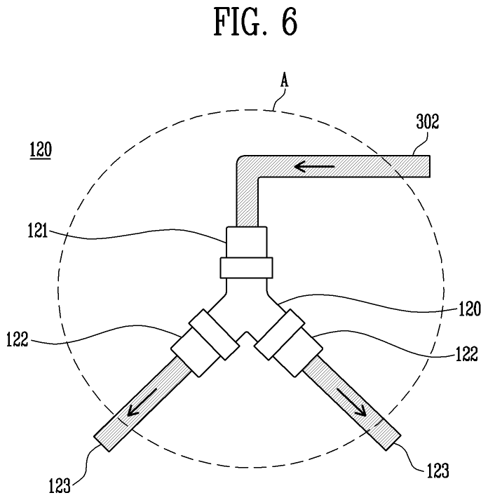

FIG. 4 is a diagram illustrating a manifold portion and an injection pipe according to an Example of the present disclosure; FIG. 5 is a diagram illustrating an electrolyte injection system according to an Example of the present disclosure; and FIG. 6 is an enlarged perspective diagram illustrating area A of FIG. 4 and FIG. 5.

Referring to FIGS. 4 and 5, an electrolyte solution supply portion 300 may comprise an electrolyte solution pump 301. An electrolyte solution pump may inject an electrolyte solution into a manifold portion 100. An electrolyte solution pump may transfer an electrolyte solution by power. For example, an electrolyte solution may be injected into a manifold portion 100 by the pressure of an electrolyte solution pump. For example, an electrolyte solution pump may be a motor.

Through this, an electrolyte solution may be sufficiently transferred to a manifold portion 100 even when the electrolyte solution supply portion is not positioned higher than the manifold portion 100.

Referring to FIGS. 4 and 5, an electrolyte solution supply portion 300 may be connected to a manifold portion 100. A manifold portion 100 may comprise at least one or more manifolds 120.

In addition, an electrolyte solution pump 301 may be positioned relatively higher than a manifold 120 so that an electrolyte solution may flow into the manifold 120 through gravity rather than the pressure of a pump.

An electrolyte solution supply portion 300 may be connected to a manifold portion 100. An electrolyte solution supply portion 300 may be connected to a first coupling hole 121 of a manifold 120. Therefore, an electrolyte solution accommodated in an electrolyte solution pump 301 will be injected into a manifold through a first coupling hole 121 of the manifold 120.

Referring to FIG. 4, an electrolyte solution pump comprises a discharge hole (not shown) through which an electrolyte solution is discharged, and the discharge hole is connected to a first coupling hole 121 of a manifold so that the electrolyte solution may be injected to the manifold in a fixed amount without being leaked to the outside.

An electrolyte solution pump may comprise a control valve (not shown) capable of controlling the opening and closing of a discharge hole. When a control valve closes a discharge hole, an electrolyte solution is not discharged, and when a discharge hole is opened, an electrolyte solution may be discharged. Since the injection speed of an electrolyte solution may be controlled according to the degree to which a discharge hole is opened, a control valve may control the injection speed of an electrolyte solution.

To this end, an electrolyte solution injection system of the present disclosure may further comprise a control portion (not shown). A control portion may control the injection speed or injection amount of an electrolyte solution. A control portion may control a control valve.

Referring to FIG. 5, an electrolyte solution supply portion 300 may further comprise an electrolyte solution transfer hose 302. An electrolyte solution transfer hose 302 may connect an electrolyte solution supply portion 300 and a manifold 100. An electrolyte solution transfer hose 302 may connect an electrolyte solution supply portion 300 and a first coupling hole 121. One end of an electrolyte solution transfer hose 302 will be connected to a discharge hole, and the other end will be connected to a first coupling hole 121.

Through this, even when an electrolyte solution supply portion 300 and a manifold portion 100 are separated from each other, an electrolyte solution may be transferred to a manifold portion 100 by an electrolyte solution transfer hose 302.

When an electrolyte solution transfer hose 302 is further included, an electrolyte solution may be stably supplied even at a relatively long distance. Through this, the process design can be changed in consideration of the volume and installation area of an electrolyte solution injection system, and thus the design easiness and efficiency may be improved.

When there are a plurality of manifolds 120 connected to an electrolyte solution supply portion 300, the electrolyte solution supply system 300 may comprise a plurality of electrolyte solution transfer hoses 302 connected to each manifold. Through this, an electrolyte solution may be accurately and rapidly supplied from an electrolyte solution supply portion to the manifolds.

Referring to FIG. 5, a manifold portion 100 receives an electrolyte solution from an electrolyte solution supply portion and transfers the electrolyte solution to an injection pipe 200.

A manifold portion 100 may comprise at least one manifold 120 and a connecting portion 123. A connecting portion 123 may connect a manifold 120 and an injection tube 200. An electrolyte solution may be transferred via a connecting portion. For example, a connecting portion 123 may be a pipe or a hose.

A manifold may further comprise a first coupling hole 121 for receiving an electrolyte solution from an electrolyte solution supply portion 300 and a second coupling hole 122 for injecting an electrolyte solution into an injection pipe.

A first coupling hole 121 and a second coupling hole 122 may communicate with each other inside a manifold 120. Therefore, an electrolyte solution flowing into a first coupling hole 121 may flow out to a second coupling hole 122.

The distance from the center of a manifold to a first coupling hole and the distance from the center of the manifold to a second coupling hole may be variable. The center of a manifold may be inside the manifold. For example, referring to FIG. 6, a manifold may be provided in a Y shape by one first coupling hole 121 and two second coupling holes 122. The point where a first coupling hole 121 and a second coupling hole 122 extend and meet together may be the center of a manifold.

Therefore, the length from the center of a manifold to a first coupling hole may be variable. The length from the center of a manifold to a first coupling hole may be different from the length from the center of the manifold to a second coupling hole. For example, the length from the center of a manifold to a first coupling hole may be longer than the length from the center of the manifold to a second coupling hole.

The first coupling hole 121 may be extended to be directly connected to an electrolyte solution supply portion 300. A second coupling hole 122 may be extended to be directly connected to an injection pipe 200. In the case of comprising a plurality of second coupling holes, the lengths of second coupling holes may be different from each other according to positions of a manifold and an injection pipe.

A manifold 120 may have a narrow internal flow path to prevent vortex formation. Paths from the center of a manifold to a first coupling hole and a second coupling hole may be narrow.

According to an Example, a manifold portion may form a Y shape. A first coupling hole of a Y-shaped manifold receives an electrolyte solution from an electrolyte solution supply portion, and the electrolyte solution may be branched at the center of the Y shape and be discharged through a plurality of second coupling holes. In this case, since the electrolyte solution is transferred via narrow paths, a flow in an opposite direction of the flow of the electrolyte solution is not formed, which has an effect of inhibiting vortex generation.

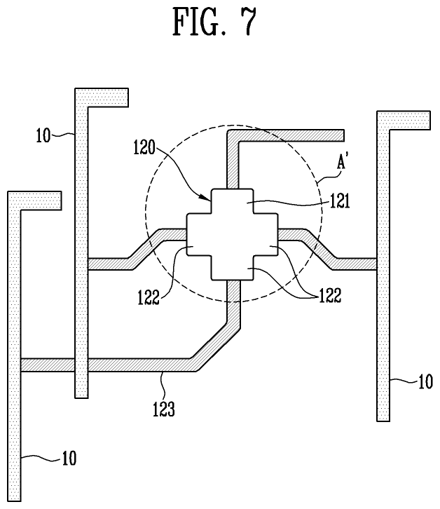

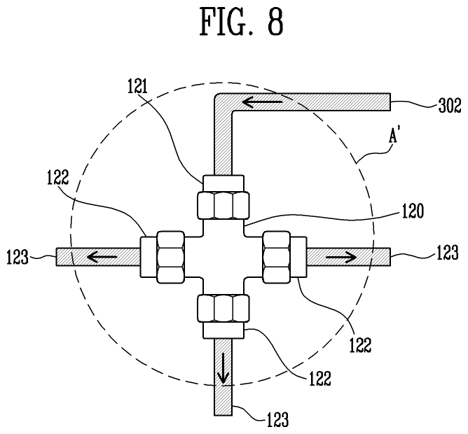

According an Example, a manifold portion may form a cross shape. Referring to FIGS. 7 and 8, a manifold portion 100 may form a shape to be connected to three injection pipes. When the number of injection tubes increases, the injection amount per hour increases, which has an effect of increasing production efficiency.

Similarly, a path from a manifold to each injection hole forms a narrow passage so that vortex generation may be inhibited.

In a manifold 120, a first coupling hole 121 may be positioned relatively higher than a second coupling hole 122. Through this, a reverse flow of an electrolyte solution injected into a manifold may be prevented. In addition, an electrolyte solution may be naturally discharged to a second coupling hole 122 by gravity so that the amount of an electrolyte solution remaining inside a manifold 120 may be reduced.

A manifold portion 100 may comprise a plurality of second coupling holes 122. At least one of the plurality of second coupling holes may be located lower than a first coupling hole 121. Preferably, all of the plurality of second coupling holes may be located lower than a first coupling hole 121. Through this, injection of an electrolyte solution may be effectively performed.

According to an Example, even when a manifold portion 100 further comprises a connecting portion 123, a second coupling hole connected to the connecting portion may be connected to the connecting portion at a relatively lower position than a first coupling hole.

According to an Example, even when an electrolyte solution supply portion 300 further comprises an electrolyte solution transfer hose 302, a second coupling hole of a manifold may be connected to a connecting portion or injection tubes at a relatively lower position than a first coupling hole.

As described above, in the process of injecting an electrolyte solution into a battery pouch, an electrolyte injection system according to an Example of the present disclosure may inhibit the generation of a vortex generated during the transfer of an electrolyte solution to allow for the injection of a fixed amount, thereby improving battery quality and performance. In addition, since an electrolyte solution may be injected to a large number of injection pipes, an increase of production efficiency can be expected.

Although the present disclosure has been described above with limited Examples and drawings, the present disclosure is not limited thereby, and various modifications and variations are possible by those of ordinary skill in the art to which the present disclosure belongs within the equivalent range of the technical principle and claims of the present disclosure.

What is claimed is:

1. An electrolyte injection system supplying an electrolyte solution to a battery pouch accommodating an electrode assembly, the electrolyte injection system comprising:
an injection pipe for injecting the electrolyte solution through an opening formed on the battery pouch;
an electrolyte solution supply portion comprising an electrolyte solution pump; and
a manifold portion connecting the injection pipe and the electrolyte solution supply portion,
wherein the manifold portion comprises at least one Y-shaped manifold.

2. The electrolyte injection system according to claim 1, wherein the manifold comprises a first coupling hole for receiving the electrolyte solution from the electrolyte solution supply portion; and a second coupling hole for supplying the electrolyte solution introduced through the first coupling hole to the injection pipe.

3. The electrolyte injection system according to claim 2, wherein the second coupling hole is located relatively lower than the first coupling hole so that the manifold may form an inclination.

4. The electrolyte injection system according to claim 2, wherein the manifold portion further comprises a connecting portion connected to the second coupling hole.

5. The electrolyte injection system according to claim 1, wherein the electrolyte solution pump is located above the manifold.

6. The electrolyte injection system according to claim 1, wherein the electrolyte solution supply portion further comprises an electrolyte solution transfer hose for transferring the electrolyte solution to the manifold.

7. The electrolyte injection system according to claim 1, wherein the electrolyte solution supply portion further comprises a control valve controlling supply of the electrolyte solution.

8. An electrolyte injection system supplying an electrolyte solution to a battery pouch accommodating an electrode assembly, the electrolyte injection system comprising:
an injection pipe for injecting the electrolyte solution through an opening formed on the battery pouch;
an electrolyte solution supply portion comprising an electrolyte solution pump; and
a manifold portion connecting the injection pipe and the electrolyte solution supply portion,
wherein the manifold portion comprises at least one cross-shaped manifold.
